(19) United States
(12) Patent Application Publication
(10) Pub. No.: US 2025/0363373 A1
(43) Pub. Date: Nov. 27, 2025

(54) SELF-SUPERVISED REPRESENTATION LEARNING WITH MULTI-SEGMENTAL INFORMATIONAL CODING

(71) Applicant: Rensselaer Polytechnic Institute, Troy, NY (US)

(72) Inventors: Chuang Niu, Troy, NY (US); Ge Wang, Loudonville, NY (US)

(73) Assignee: Rensselaer Polytechnic Institute, Troy, NY (US)

(21) Appl. No.: 18/874,658

(22) PCT Filed: Jun. 13, 2023
(86) PCT No.: PCT/US2023/025137

§ 371 Date: Dec. 13, 2024

Related U.S. Application Data
(60) Provisional application No. 63/351,610, filed on Jun. 13, 2022.
(60) Provisional application No. 63/472,618, filed on Jun. 13, 2023.

(51) Int. Cl. G06N 3/0895; G06N 3/045

(52) U.S. Cl. CPC G06N 3/0895; G06N 3/045

(57) ABSTRACT

In one embodiment, there is provided a self-supervised representation learning (SSRL) circuitry. The SSRL circuitry includes a transformer circuitry configured to receive input data. The input data includes an input batch containing a number, N, of input data sets. The transformer circuitry is configured to transform the input batch into a plurality of training batches. Each training batch contains the number N training data sets. The SSRL circuitry further includes for each training batch: a respective encoder circuitry, a respective projector circuitry, and a respective partitioning circuitry. The respective encoder circuitry is configured to encode each training data set into a respective representation feature. The respective projector circuitry is configured to map each representation feature into an embedding space as a respective embedding feature vector.

### CROSS REFERENCE TO RELATED APPLICATION(S)

This application claims the benefit of U.S. Provisional Application No. 63/351,610, filed Jun. 13, 2022, and U.S. Provisional Application No. 63/472,618, filed Jun. 13, 2023, which are incorporated by reference as if disclosed herein in their entireties.

### GOVERNMENT LICENSE RIGHTS

This invention was made with government support under award numbers CA233888, CA237267, HL 151561, EB031102, and EB032716, all awarded by the National Institutes of Health (NIH). The government has certain rights in the invention.

### FIELD

The present disclosure relates to a self-supervised representation learning, in particular to, self-supervised representation learning with multi-segmental informational coding.

### BACKGROUND

Self-supervised representation learning (SSRL) maps high-dimensional data into a meaningful embedding space, where samples of similar semantic content are close to each other. SSRL has been a core task in machine learning and has experienced relatively rapid progress over the past few years. Deep neural networks pre-trained on large-scale unlabeled datasets via SSRL have demonstrated desirable characteristics, including relatively strong robustness and generalizability, improving various down-stream tasks when annotations are scarce. An effective approach for SSRL is to enforce semantically similar samples (i.e., different transformations from a same instance) close to each other in an embedding space. Simply maximizing similarity or minimizing Euclidean distance between embedding features of similar semantic samples tends to produce trivial solutions, e.g., all samples have a same embedding.

### SUMMARY

In some embodiments, there is provided a self-supervised representation learning (SSRL) circuitry. The SSRL circuitry includes a transformer circuitry configured to receive input data. The input data includes an input batch containing a number, N, of input data sets. The transformer circuitry is configured to transform the input batch into a plurality of training batches. Each training batch contains the number N training data sets. The SSRL circuitry further includes for each training batch: a respective encoder circuitry, a respective projector circuitry, and a respective partitioning circuitry. The respective encoder circuitry is configured to encode each training data set into a respective representation feature. The respective projector circuitry is configured to map each representation feature into an embedding space as a respective embedding feature vector. The respective partitioning circuitry is configured to partition each embedding feature vector into a number, S, segments. Each segment has a dimension, D_{S}. Each segment corresponds to a respective attribute type, and each segment contains at least one instantiated attribute corresponding to the associated attribute type for the segment.

In some embodiments, the SSRL circuitry further includes, for each training batch, a respective normalizing circuitry configured to normalize each segment of the corresponding partitioned embedding feature vector to a probability distribution over D_{S} instantiated attributes using a softmax function. The SSRL circuitry further includes a joint probability circuitry configured to determine an empirical joint probability distribution between the embedding features of the training data sets over the plurality of training batches.

In some embodiments of the SSRL circuitry, each encoder circuitry and each projector circuitry corresponds to a respective multilayer perceptron (MLP).

In some embodiments of the SSRL circuitry, the input data is selected from the group including image data, text, and speech data.

In some embodiments of the SSRL circuitry, a number of training batches is two.

In some embodiments, there is provided a method for self-supervised representation learning (SSRL). The method includes receiving, by a transformer circuitry, input data. The input data includes an input batch containing a number, N, of input data sets. The method further includes transforming, by the transformer circuitry, the input batch into a plurality of training batches. Each training batch contains the number N training data sets. The method further includes, for each training batch: encoding, by a respective encoder circuitry, each training data set into a respective representation feature, mapping, by a respective projector circuitry, each representation feature into an embedding space as a respective embedding feature vector; and partitioning, by a respective partitioning circuitry, each embedding feature vector into a number, S, segments. Each segment has a dimension, D_{S}. Each segment corresponds to a respective attribute type. Each segment contains at least one instantiated attribute corresponding to the associated attribute type for the segment.

In some embodiments, the method further includes, for each training batch, normalizing, by a respective normalizing circuitry, each segment of the corresponding partitioned embedding feature vector to a probability distribution over D_{S} instantiated attributes using a softmax function. The method further includes determining, by a joint probability circuitry, an empirical joint probability distribution between the embedding features of the training data sets over the plurality of training batches.

In some embodiments of the method, each encoder circuitry and each projector circuitry corresponds to a respective multilayer perceptron (MLP).

In some embodiments of the method, the input data is selected from the group including image data, text, and speech data.

In some embodiments, the method further includes determining, by a training circuitry, a pure entropy loss based, at least in part, on an empirical joint probability distribution. Minimizing the pure entropy loss during training is configured to maximize a joint entropy over a number of selected segments.

In some embodiments of the method, a pure entropy loss function is:

$${L}_{ent} = \frac{1}{{S}^{2}} {\sum }_{{s}^{′} = 1}^{S} {\sum }_{{s}^{″} = 1}^{S} {\sum }_{{d}^{′} = 1}^{{D}_{s}} {\sum }_{{s}^{″} = 1}^{{D}_{s}} ( 1 - ( {s}^{′} = {s}^{″} , {d}^{′} \neq {d}^{″} ) ) p ( {s}^{′} , {s}^{″} , {d}^{′} , {d}^{″} ) log ( p ( {s}^{′} , {s}^{″} , {d}^{′} , {d}^{″} ) ) .$$

In some embodiments, the method further includes determining by the training circuitry, an enhanced loss based, at least in part on the pure entropy loss, and based, at least in part on an inner product term. The enhanced loss is configured to enhance a transformation invariance of a plurality of features.

In an embodiment, there is provided a self-supervised representation learning (SSRL) system. The SSRL system includes a computing device and an SSRL circuitry. The computing device includes a processor, a memory, an input/output circuitry, and a data store. The SSRL circuitry includes a transformer circuitry configured to receive input data. The input data includes an input batch containing a number, N, of input data sets. The transformer circuitry is configured to transform the input batch into a plurality of training batches. Each training batch contains the number N training data sets. The SSRL circuitry further includes for each training batch: a respective encoder circuitry, a respective projector circuitry, and a respective partitioning circuitry. The respective encoder circuitry is configured to encode each training data set into a respective representation feature. The respective projector circuitry is configured to map each representation feature into an embedding space as a respective embedding feature vector. The respective partitioning circuitry is configured to partition each embedding feature vector into a number, S, segments. Each segment has a dimension, D_{S}. Each segment corresponds to a respective attribute type, and each segment contains at least one instantiated attribute corresponding to the associated attribute type for the segment.

In some embodiments of the SSRL system, the SSRL circuitry further includes, for each training batch, a respective normalizing circuitry configured to normalize each segment of the corresponding partitioned embedding feature vector to a probability distribution over D_{S} instantiated attributes using a softmax function. The SSRL circuitry further includes a joint probability circuitry configured to determine an empirical joint probability distribution between the embedding features of the training data sets over the plurality of training batches.

In some embodiments of the SSRL system, each encoder circuitry and each projector circuitry corresponds to a respective multilayer perceptron (MLP).

In some embodiments of the SSRL system, the input data is selected from the group including image data, text, and speech data.

In some embodiments, the SSRL system further includes a training circuitry configured to determine a pure entropy loss based, at least in part, on an empirical joint probability distribution. Minimizing the pure entropy loss during training is configured to maximize a joint entropy over a number of selected segments.

In some embodiments of the SSRL system, a pure entropy loss function is:

$${L}_{ent} = \frac{1}{{S}^{2}} {\sum }_{{s}^{′} = 1}^{S} {\sum }_{{s}^{″} = 1}^{S} {\sum }_{{d}^{′} = 1}^{{D}_{s}} {\sum }_{{s}^{″} = 1}^{{D}_{s}} ( 1 - ( {s}^{′} = {s}^{″} , {d}^{′} \neq {d}^{″} ) ) p ( {s}^{′} , {s}^{″} , {d}^{′} , {d}^{″} ) log ( p ( {s}^{′} , {s}^{″} , {d}^{′} , {d}^{″} ) ) .$$

In some embodiments of the SSRL system, the training circuitry is configured to determine an enhanced loss based, at least in part on the pure entropy loss, and based, at least in part on an inner product term. The enhanced loss is configured to enhance a transformation invariance of a plurality of features.

In some embodiments, there is provided a computer readable storage device. The device has stored thereon instructions that when executed by one or more processors result in the following operations including: any embodiment of the method.

### BRIEF DESCRIPTION OF DRAWINGS

The drawings show embodiments of the disclosed subject matter for the purpose of illustrating features and advantages of the disclosed subject matter. However, it should be understood that the present application is not limited to the precise arrangements and instrumentalities shown in the drawings, wherein:

FIG. 1 is a sketch illustrating one example feature vector including embedded feature partitions, according to several embodiments of the present disclosure;

FIG. 2 illustrates a functional block diagram of one example self-supervised representation learning circuitry that graphically illustrates joint entropy, according to one embodiment of the present disclosure;

FIG. 3 illustrates a functional block diagram of a self-supervised representation learning system (SSRL) that includes a self-supervised representation learning circuitry, according to several embodiments of the present disclosure; and

FIG. 4 is a flowchart of operations for self-supervised representation learning, according to various embodiments of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure relates to a self-supervised representation learning (SSRL) system, in particular to, an SSRL system with MUlti-Segmental Informational Coding

(“MUSIC”). An apparatus, system, and/or method, according to the present disclosure, is configured to divide, i.e., partition, an embedding feature vector corresponding to a batch of input data sets into a plurality of segments, with each segment corresponding to a respective attribute type (i.e., general attribute). Each segment is configured to contain at least one instantiated attribute that corresponds to the associated attribute type for the segment. The apparatus, system, and/or method are configured to utilize information theory, e.g., entropy, and an entropy-based cost function, to help avoid trivial solutions.

By way of theoretical background, and using image data as a nonlimiting example, it may be appreciated that an object may be represented by a plurality of attributes, including, but not limited to, object parts, textures, shapes, etc. An embedding vector may divided into a number, S segments (e.g., Seg-1, Seg-2, . . . , Seg-S). Different segments are configured to represent different attributes. For example, Seg-1 may represent object part, Seg-2 may represent texture, and Seg-3 may represent shape, respectively. Each segment is configured to instantiate a number, D_{S}, different features. Continuing with this example, Seg-2 may be configured to represents samples with different textures (e.g., dot texture, stripe texture, etc.). Thus, different instantiated features within each segment are configured to be discriminative from each other. A specific instance may then be uniquely represented by a set of pre-defined attributes. An entropy-based loss function may then be configured to facilitate learning MUSIC embedding features from unlabeled datasets. Furthermore, theoretical analysis, based on information theory, illustrates why meaningful features can be learned while trivial solutions are avoided.

Advantageously, MUSIC allows an information theory-based representation learning framework. Theoretical analysis supports that optimized MUSIC embedding features are transform-invariant, discriminative, diverse, and non-trivial. It may be appreciated that the MUSIC technique, according to the present disclosure, does not require an asymmetric network architecture with an extra predictor module, a large batch size of contrastive samples, a memory bank, gradient stopping, or momentum updating. Empirical results suggest that MUSIC does not depend on a relatively high dimension of embedding features or a relatively deep projection head, thus, efficiently reducing a memory and computation cost. In one nonlimiting example, experimental data suggests that MUSIC achieves acceptable results in terms of linear probing on the ImageNet dataset.

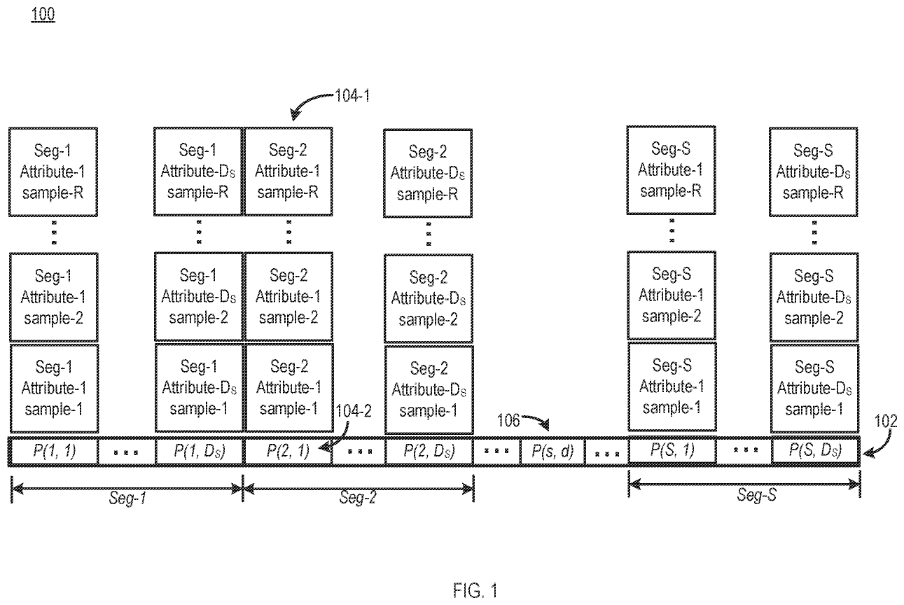

FIG. 1 is a sketch 100 illustrating one example 102 embedding feature vector including embedded feature partitions, according to several embodiments of the present disclosure. In one nonlimiting example, an image may be represented by a plurality of attributes including, but not limited to, general object parts, textures, shapes, etc. However, this disclosure is not limited in this regard. Other types of input data, for example, text data, speech data, etc., may be similarly represented by a plurality of associated attributes. The example embedding feature vector 102 includes a number, S, segments Seg-1, Seg-2, . . . , Seg-S.

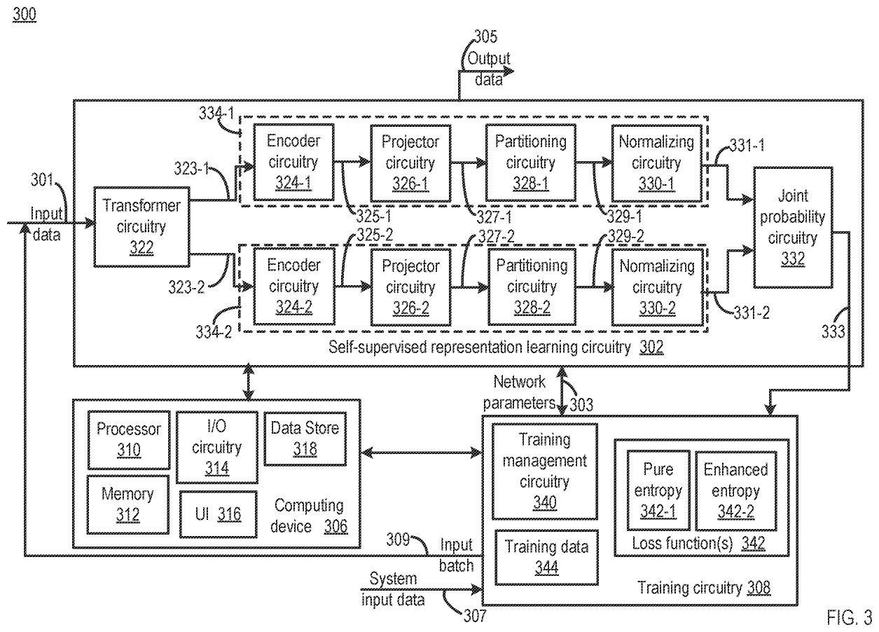

Generally, an SSRL circuitry, e.g., SSRL circuitry 302 of FIG. 3, as will be described in more detail below, may be configured to divide an embedding feature vector into a plurality of segments (Seg-1, Seg-2, . . . , Seg-S). Each segment corresponds to a respective attribute type (i.e., “general attribute”). Each segment may then include a plurality of instantiated attributes corresponding to the associated attribute type for the segment. For example, for image data, segment Seg-1 may correspond to an object part attribute, segment Seg-2 may correspond to a texture attribute, and segment Seg-S may correspond to a shape attribute. A respective general attribute of each segment may include a plurality of instantiations, and different instantiated attributes within a same segment are configured to be discriminative from each other.

Each attribute has an associated probability p(s, d) 106 corresponding to the probability that an input data set, e.g., image data, belongs to the d^{th} instantiated attribute of the s^{th} segment. For example, for segment Seg-2 that represents texture, each attribute Seg-2 Attribute-1, . . . , Seg-2 Attribute-D_{S} may represent a respective texture, e.g., dot texture, stripe texture, etc. Each attribute may have one or more associated samples, e.g., grouping 104-1 that includes Seg-2 Attribute-1 samples sample-1 through sample-R. It may be appreciated that each sample corresponds to image data that includes the associated attribute. The value p(s, d) in each unit denotes the probability of an image belongs to the d^{th} instantiated attribute of s^{th} segment, s=1, . . . , S, and d=1, . . . , D_{S}.

Thus, each embedding feature vector may be partitioned into a plurality of segments. Each segment is configured to correspond to a respective attribute type. Each segment is configured to contain at least one instantiated attribute corresponding to the associated attribute type for the segment.

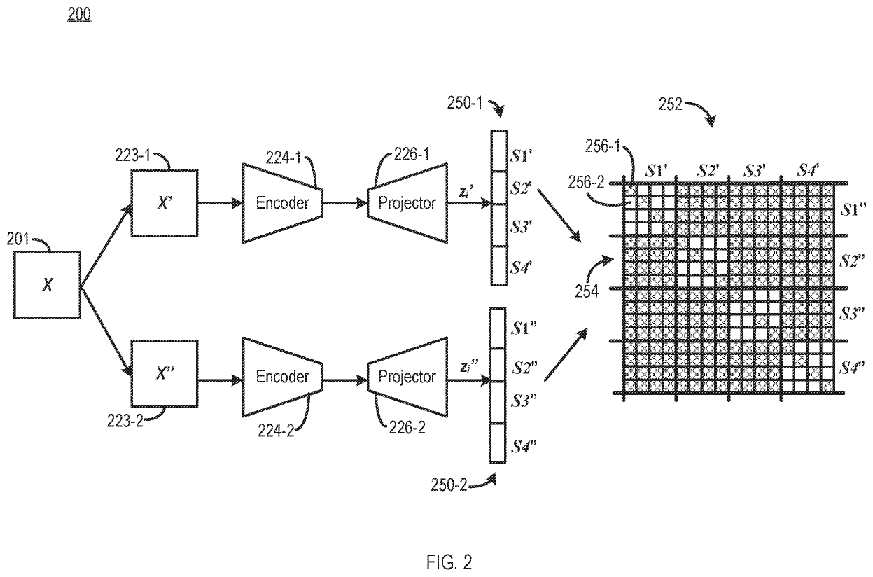

FIG. 2 illustrates a functional block diagram 200 of one example self-supervised representation learning (SSRL) circuitry that graphically illustrates joint entropy, according to one embodiment of the present disclosure. It may be appreciated that example 200 illustrates a twin architecture and may be configured to use a same network for both branches. Example 200 includes an input data set (X) 201, and two transformed, i.e., training, data sets (X′, X″) 223-1, 223-2. A first training data set, X′ 223-1 may be provided to a first branch that includes a first encoder 224-1 and a first projector 226-1. An output of the first encoder 224-1 corresponds to an input to the first projector 226-1. An output of the first projector corresponds to a first embedding feature

$$( {z}_{i}^{′} ) .$$

Similarly, a second training data set, X″ 223-2 may be provided to a second branch that includes a second encoder 224-2 and a second projector 226-2. An output of the second encoder 224-2 corresponds to an input to the second projector 226-2. An output of the second projector corresponds to a second embedding feature

$$( {z}_{i}^{″} ) .$$

During training, input images

$$X = {\{ {x}_{i} \}}_{i = 1}^{N}$$

may be mapped to two distorted sets

$${X}^{′} = {\{ {x}_{i}^{′} \}}_{i = 1}^{N} and {X}^{″} = {\{ {x}_{i}^{″} \}}_{i = 1}^{N} ,$$

where N is the batch size. In one nonlimiting example, a common transformation distribution, i.e., random crops combined with color distortions may be used to generate a number of training samples. Two batches of distorted images X′ and X″ may then be respectively fed to the two branches. Each encoder may correspond to a function F(·;θ_{F}) where the symbol · corresponds to a training data set. Each projector may correspond to a function P(·;θ_{P}) where the symbol · corresponds to F(·;θ_{F}). An output of each encoder 224-1, 224-2 may be used as a respective representation feature. Each projector, i.e., projection head, is configured to map the representation feature into an embedding space during training. It may be appreciated that an SSRL circuitry, system and/or method are not limited to this twin architecture. In some embodiments, a SSRL circuitry, system and/or method may include two branches with different parameters or of heterogeneous networks. In some embodiments, a SSRL circuitry, system and/or method may be configured to receive input data corresponding to other input modalities (e.g., text, audio, etc.).

The following description may be best understood when considering FIG. 1 and FIG. 2 together. As described herein, MUlti-Segmental Informational Coding (MUSIC) is configured for self-supervised representation learning. The embedding features of the two branches may be denoted as:

$${z}_{i}^{′} = P ( F ( {x}_{i}^{′} ; {θ}_{F} ) ; {θ}_{P} ) ∈ {R}^{D} , and {z}_{i}^{″} = P ( F ( {x}_{i}^{″} ; {θ}_{F} ) ; {θ}_{P} ) ∈ {R}^{D} ,$$

where D is the feature dimension. As described herein, the embedding feature zᵢ may be divided, i.e., partition, into a plurality of segments, denoted by zᵢ(s, d), s=1, . . . , S, d=1, . . . , D_{S}, where S is the number of segments, D_{S} is the dimension of each segment, and D=D_{S}×S corresponds to a dimension of an embedding space. In an embodiment, the MUSIC technique may be configured to evenly split the embedding vector. It is contemplated that the MUSIC technique may be configured to implement uneven configurations.

Each segment may be normalized to a probability distribution

$${p}_{i}^{′} ( {s}^{′} , {d}^{′} )$$

over D_{S} instantiated attributes using a softmax function, i.e.,

$${p}_{i}^{′} ( {s}^{′} , {d}^{′} ) = \frac{exp ( {z}_{i}^{′} ( s , d ) )}{{\sum }_{k = 1}^{{D}_{s}} exp ( {z}_{i}^{′} ( s , k ) )} , \qquad ( 1 )$$

A probability distribution pᵢ^{″}(s, d) for the other branch may be similarly determined. Thus, the MUSIC technique may be interpreted as a combination of a plurality of classifiers or cluster operators configured to implement different classification criteria learned in a data-driven fashion.

Considering and entropy loss, and based, at least in part, on corresponding probability distributions over a plurality of segments, an empirical joint distribution p(s′,s″, d′, d″) between the embedding features of two transformations may be determined over a batch of samples as:

$$p ( {s}^{′} , {s}^{″} , {d}^{′} , {d}^{″} ) = \frac{1}{N} {\sum }_{i = 1}^{N} {p}_{i}^{′} ( {s}^{′} , {d}^{′} ) {p}_{i}^{″} ( s , {d}^{″} ) , \qquad ( 2 )$$

With the empirical joint distribution, two versions of the loss function may be defined. A first version Lₑₙₜ may be described as a pure entropy-based loss function:

$${L}_{out} = \frac{1}{{S}^{2}} {\sum }_{{s}^{′} = 1}^{S} {\sum }_{{s}^{″} = 1}^{S} {\sum }_{{d}^{′} = 1}^{{D}_{s}} {\sum }_{{s}^{″} = 1}^{{D}_{s}} ( 1 - ( {s}^{′} = {s}^{″} , {d}^{′} \neq {d}^{″} ) ) p ( {s}^{′} , {s}^{″} , {d}^{′} , {d}^{″} ) log ( p ( {s}^{′} , {s}^{″} , {d}^{′} , {d}^{″} ) ) , \qquad ( 3 )$$

where [symbol] (s′=s″, d′≠d″) is an indicator function that equals 1 if s′=s″ and d′≠d″, otherwise it is equal to 0. An empirical joint distribution can be modeled as a block matrix 252 as illustrated in FIG. 2. Continuing with Equation (3), (1− [symbol] (s′=s″, d′≠d″)) corresponds to maintaining, i.e., selecting, diagonal elements and elements of the off-diagonal blocks. In the block matrix 252 of FIG. 2, crosshatch squares correspond to elements that are maintained, e.g., 254 and 256-1, and white squares correspond to elements that are not maintained, e.g., 256-2. It may be appreciated that minimizing this loss function is configured to maximize a joint entropy over the selected elements. It may be further appreciated that this single loss function is configured to facilitate learning relatively meaningful features.

To enhance the transformation invariance of features, an additional term may be included configured to maximize an inner product between the embedding features from the plurality of transformations. An enhanced loss function may then be defined as:

$$L = {L}_{ent} - λ \frac{1}{NS} {\sum }_{i = 1}^{N} {\sum }_{s = 1}^{S} {\sum }_{d = 1}^{{D}_{s}} log ( {p}_{i}^{′} ( s , d ) {p}_{i}^{″} ( s , d ) ) , \qquad ( 4 )$$

where λ is a balancing factor. In one nonlimiting example, λ may be set equal to 1. Based on experimental data, it appears that λ need not be relatively very small or relatively large to achieve adequate balancing. Since

$${p}_{i}^{′} ( s , d ) and {p}_{i}^{″} ( s , d )$$

are the probabilities, maximizing their inner product is configured to ensure the corresponding network makes relatively consistent assignments over all segments between two transformations of a same image. Each segment may then be encouraged to be a one-hot vector for a maximum inner product. Thus, it may be appreciated that this additional term is configured to promote a transformal invariance and relatively confident assignments over a number of different attributes. One difference of this term from the entropy loss term is a sample-specific constraint while entropy is a statistical measure.

In one nonlimiting example, an SSRL (i.e., MUSIC) technique, according to the present disclosure, may be implemented, with a PyTorch-style pseudo code as illustrated in Table 1.

TABLE 1
Algorithm 1: PyTorch-style pseudocode for MUSIC

```
# f: network function
# lambda: weight on the transform invariance loss term
# N: batch size
# D: dimensionality of the embeddings
# D_S: dimensionality of each segment
# S=D/D_S: number of segments
#
# select: select the elements on diagonal and in off-diagonal blocks
for i in loader: # load a batch with N samples
  # two randomly augmented versions of x
  x′, x″ = augment(x)
  # compute embeddings
  z′ = augment(x’)
  z″ = augment(x’’)
  # multi-segment discriminative coding
  x′ = torch.reshape(x′, [N, −1, D_S]) # N×S×D_S
  x″ = torch.reshape(x″, [N, −1, D_S]) # N×S×D_S
  p′ = torch.softmax(x′, dim=2) # transform to probability
  p″ = torch.softmax(x″, dim=2) # transform to probability
  # compute transform invariance loss
  loss_TI = −torch.log((p′*p″) .sum(dim=2)) .mean( )
  # compute entropy loss
  p′ = torch.reshape(p′, [N, D]) # N × D
  p″ = torch.reshape(p″, [N, D]) # N × D
  p = torch.einsum(’np , nq−>pq’ , [p′, p″]) / N # compute empirical
  joint distribution
  p_s = select(p)
  loss_ent = (p_s * torch.log(p_s)) .sum( ) / (S × S)
  # final loss
  loss = loss_ent + lambda * loss_TI # lambda=1 by default
  # optimization step
  loss.backward( )
  optimizer.step( )
```

It may be appreciated that the entropy loss, as described herein, is configured to optimize relatively meaningful embedding features. The entropy loss function includes two parts, including the entropy over diagonal elements, e.g., element 256-1, and the entropy over the elements of off-diagonal blocks, e.g., block 254 of FIG. 2. Formally, the two-part entropy loss function may be written as:

$${L}_{ent} = \frac{1}{S} {\sum }_{{s}^{′} , {s}^{″} , {s}^{′} = {s}^{″}} {\sum }_{{d}^{′} , {d}^{″} , {d}^{′} = {d}^{″}} p ( {s}^{′} , {s}^{″} , {d}^{′} , {d}^{″} ) log ( p ( {s}^{′} , {s}^{″} , {d}^{′} , {d}^{″} ) ) + \frac{1}{S ( S - 1 )} {\sum }_{{s}^{′} , {s}^{″} , {s}^{′} \neq {s}^{″}} {\sum }_{{d}^{′} , {d}^{″}} p ( {s}^{′} , {s}^{″} , {d}^{′} , {d}^{″} ) log ( p ( {s}^{′} , {s}^{″} , {d}^{′} , {d}^{″} ) ) . \qquad ( 5 )$$

For the first part, i.e., the term to the left of the +, it can be demonstrated that an optimal solution is ∀s, d,

$${p}_{i}^{′} ( s , d ) = {p}_{i}^{″} ( s , d ) ,$$

where

$${p}_{i}^{′} ( s , d ) and {p}_{i}^{″} ( s , d )$$

are one-hot vectors, and

$$\frac{1}{N} {\sum }_{d = 1}^{N} {p}_{i} ( s , d ) = \frac{1}{{D}_{S}} .$$

For the second part, i.e., the term to the right of the +, it may be appreciated that the optimal solution to maximize the joint entropy over the off-diagonal block items is ∀s′, s″, d′, d″, s′≠s″,

$$p ( {s}^{′} , {s}^{″} , {d}^{′} , {d}^{″} ) = \frac{1}{{( {D}_{S} )}^{2}} ;$$

i.e., a batch of samples are evenly assigned over each off-diagonal block.

Regarding transform invariance, it may be appreciated that a solution where p′(s,:) and p″(s,:) are one-hot vectors and equal to each other means that the learned MUSIC embeddings are invariant to transformations, and a sample may be confidently represented by a single instantiated attribute within each and every segment.

Regarding nontrivial solution, a solution where

$$\frac{1}{N} {\sum }_{d = 1}^{N} {p}_{i} ( s , d ) = \frac{1}{{D}_{S}}$$

means that each segment evenly partitions a batch of samples over D_{S} instantiated attributes. Since

$${p}_{i}^{′} ( s , d ) and {p}_{i}^{″} ( s , d )$$

are one-hot vectors, a trivial solution where all samples have the same embedding features or are assigned to the same attribute for each segment can be avoided.

Regarding minimum redundancy, considering FIG. 1, it may be appreciated that a plurality of segments of the MUSIC embedding vector may be configured to focus on complementary attributes. In other words, the redundancy or mutual information between any two segments may be minimized. Minimizing redundancy or mutual information between any two segments may be useful for feature selection. It may be appreciated that the redundancy or mutual information between any two segments is minimized when an optimal solution is obtained. Mutual information l(s′, s″) between any segments s′ and s″ may be written as:

$$I ( {s}^{′} , {s}^{″} ) = H ( {s}^{′} ) + H ( {s}^{″} ) - H ( {s}^{′} , {s}^{″} ) = - {\sum }_{{d}^{′} = 1}^{{D}_{S}} {p}^{′} ( {s}^{′} , {d}^{′} ) log ( {p}^{′} ( {s}^{′} , {d}^{′} ) ) - {\sum }_{{d}^{″} = 1}^{{D}_{S}} {p}^{″} ( {s}^{″} , {d}^{″} ) log ( {p}^{″} ( {s}^{″} , {d}^{″} ) ) + {\sum }_{{d}^{′} = 1}^{{D}_{S}} {\sum }_{{d}^{″} = 1}^{{D}_{S}} p ( {s}^{′} , {s}^{″} , {d}^{′} , {d}^{″} ) log ( p ( {s}^{′} , {s}^{″} , {d}^{′} , {d}^{″} ) ) = - log \frac{1}{{D}_{S}} - log \frac{1}{{D}_{S}} + log \frac{1}{{( {D}_{S} )}^{2}} = 0. \qquad ( 6 )$$

The features within each segment are configured to be exclusive from each other, thus, MUSIC embedding features may be both discriminative and diverse.

It may be appreciated that the entropy-based loss function, as described herein, is configured to reduce redundancy in a non-linear way. It may be appreciated that optimal MUSIC embedding features are configured to have zero covariance between any two features in different segments and negative covariance between the features within the same segment.

As a comparison, it may be appreciated that contrastive learning is relatively effective for representation learning by maximizing a similarity between different transformations of a same instance and minimizing a similarity between a reference and other instances. It may be appreciated that MUSIC, according to the present disclosure, is configured to be consistent with contrastive learning. In an embodiment, an optimal MUSIC embedding may encode (D_{S})^{S} different samples. In one nonlimiting example, with D_{S}=80, S=102, MUSIC may be configured to represent 80¹⁰² different samples. Maximizing the joint entropy may be configured to evenly assign a batch of samples into most or all embeddings. Thus, the embedding features of most or all instances may be configured to be different from each other, similar to contrastive learning, given a sufficiently large coding capacity. It may be appreciated that contrastive learning is configured to differentiate instances by directly enforcing their features to be dissimilar, while MUSIC is configured to statistically assign instances with different assignment codes.

In an embodiment, there is provided a self-supervised representation learning (SSRL) circuitry. The SSRL circuitry includes a transformer circuitry configured to receive input data. The input data includes an input batch containing a number, N, of input data sets. The transformer circuitry is configured to transform the input batch into a plurality of training batches. Each training batch contains the number N training data sets. The SSRL circuitry further includes for each training batch: a respective encoder circuitry, a respective projector circuitry, and a respective partitioning circuitry. The respective encoder circuitry is configured to encode each training data set into a respective representation feature. The respective projector circuitry is configured to map each representation feature into an embedding space as a respective embedding feature vector. The respective partitioning circuitry is configured to partition each embedding feature vector into a number, S, segments. Each segment has a dimension, D_{S}. Each segment corresponds to a respective attribute type, and each segment contains at least one instantiated attribute corresponding to the associated attribute type for the segment.

FIG. 3 illustrates a functional block diagram of a self-supervised representation learning (SSRL) system 300 that includes an SSRL circuitry 302, according to several embodiments of the present disclosure. The SSRL system 300 may be configured to implement a MUSIC technique, as described herein. The SSRL system 300 includes the SSRL circuitry 302, a computing device 306, and may include a training circuitry 308. The SSRL circuitry 302, and/or training circuitry 308 may be coupled to or included in computing device 306.

The SSRL circuitry 302 is configured to receive input data 301 (e.g., input batch 309 from the training circuitry 308) and to provide a joint probability distribution 333 to the training circuitry 308. The training circuitry 308, e.g., training management circuitry 340, may then be configured to evaluate a pure entropy loss function 342-1, and/or an enhanced entropy loss function 342-2 based, at least in part, on the joint probability distribution 333, as described herein. The training circuitry 308, e.g., training management circuitry 340, may then be configured to adjust one or more network parameters 303 associated with SSRL circuitry 302, and one or more of the circuitries contained therein, to optimize the entropy associated with elements of an embedding feature vector, as described herein.

SSRL circuitry 302 includes a transformer circuitry 322, a plurality of encoder circuitries 324-1, 324-2, a plurality of projector circuitries 326-1, 326-2, a plurality of partitioning circuitries 328-1, 328-2, a plurality of normalizing circuitries 330-1, 330-2, and a joint probability circuitry 332. Transformer circuitry 322 is coupled to a plurality of branches 334-1, 334-2, and each branch includes a respective plurality of circuitries coupled in series. For example, a first branch 334-1, includes a first encoder circuitry 324-1 coupled to a first projector circuitry 326-1 coupled to a first partitioning circuitry 328-1 coupled to a first normalizing circuitry 330-1, and a 2^{nd} branch 334-2, includes a 2^{nd} encoder circuitry 324-2 coupled to a 2^{nd} projector circuitry 326-2 coupled to a 2^{nd} partitioning circuitry 328-2 coupled to a 2^{nd} normalizing circuitry 330-2. A respective normalizing circuitry 330-1, 330-2 of each of the plurality of branches 334-1, 334-2 is coupled to a joint probability circuitry 332.

The encoder circuitries 324-1, 324-2 correspond to the encoders 224-1, 224-2, of FIG. 2. Similarly, the projector circuitries 326-1, 326-2, correspond to the projectors 226-1, 226-2. The encoder circuitries, encoders, projector circuitries, and/or projectors may each correspond to an artificial neural network, e.g., a multilayer perceptron. However, this disclosure is not limited in this regard.

Computing device 306 may include, but is not limited to, a computing system (e.g., a server, a workstation computer, a desktop computer, a laptop computer, a tablet computer, an ultraportable computer, an ultramobile computer, a netbook computer and/or a subnotebook computer, etc.), and/or a smart phone. Computing device 306 includes a processor 310, a memory 312, input/output (I/O) circuitry 314, a user interface (UI) 316, and data store 318.

Processor 310 is configured to perform operations of SSRL circuitry 302, and/or training circuitry 308. Memory 312 may be configured to store data associated with SSRL circuitry 302, and/or training circuitry 308. I/O circuitry 314 may be configured to provide wired and/or wireless communication functionality for SSRL system 300. For example, I/O circuitry 314 may be configured to receive input data 301 and/or system input data 307 (including, e.g., training data 344) and to provide output data 305. UI 316 may include a user input device (e.g., keyboard, mouse, microphone, touch sensitive display, etc.) and/or a user output device, e.g., a display. Data store 318 may be configured to store one or more of system input data 307, training data 344, input data 301, output data 305, network parameters 303, and/or other data associated with SSRL circuitry 302, and/or training circuitry 308. Other data may include, for example, function parameters related to loss function(s) 342 (e.g., related to pure entropy loss function 342-1, and/or enhanced entropy loss function 342-2), training constraints (e.g., hyper parameters, including, but not limited to, number of epochs, batch size, projector depth, segment dimension, feature dimension, convergence criteria, etc.), etc.

Training circuitry 308 may be configured to receive and store system input data 307. System input data 307 may include training data 344, loss function(s) 342 parameters, etc.

Training data 344 may include, for example, one or more input batches of input data sets. A batch may be configured to contain a number, N, input data sets. In one nonlimiting example, each input data set may correspond to image data. However, this disclosure is not limited in this regard. In other examples, the input data sets may not correspond to image data and may include text, audio, and/or speech data. Training circuitry 308 may be further configured to receive and/or store one or more loss function(s) 342, e.g., a pure entropy loss function 342-1, and/or an enhanced entropy loss function 342-2, as described herein.

In operation, SSRL circuitry 302, e.g., transformer circuitry 322, is configured to receive input data 301. During training, input data 301 is configured to correspond to an input batch 309 that includes a number, N, input data sets. Training operations may be managed by training management circuitry 340. Generally, during training, training management circuitry 340 may be configured to provide the input batch 309 to SSRL circuitry 302, capture the joint probability distribution 332 from the SSRL circuitry 302, evaluate the loss function(s) 342, and adjust network parameters 303 to optimize operation of SSRL circuitry 302, e.g., maximizing an entropy of an associated embedding feature vector, as described herein. The network parameters 303 may be related to one or more of the encoder circuitries 324-1, 324-2, and/or the projector circuitries 326-1, 326-2. In an embodiment, the encoder circuitries 324-1, 324-2, and/or the projector circuitries 326-1, 326-2 may correspond to artificial neural networks. In one nonlimiting example, the encoder circuitries 324-1, 324-2, and/or the projector circuitries 326-1, 326-2 may correspond to multilayer perceptrons. However, this disclosure is not limited in this regard. Training operations may repeat until a stop criterion is met, e.g., a cost function threshold value is achieved, a maximum number of iterations has been reached, etc. At the end of training, network parameters 303 may be set for operation. The SSRL circuitry 302 may then be configured to map relatively high dimensional data into a meaningful embedding space, where samples of similar semantic content are configured to be relatively close to each other, while avoiding trivial solutions that all samples have a same embedding feature.

During training, the input data 301 may correspond to an input batch 309. A batch may have a batch size, N, where N corresponds to the number of data sets in a batch. A batch may be an input batch, e.g., input batch 309, or a training batch, e.g., a first training batch 323-1 or a second training batch 323-2. A subscript, i, is an index corresponding to a data set in a batch of data sets. Thus, for ease of description of training operations and corresponding to the theoretical background, as described herein, Table 2 includes a plurality of variable definitions.

```
TABLE 2
N ≡ batch size = number of data sets in a batch.
Index, i, corresponds to a data set (i = 1,..., N).
xᵢ ≡ i^{th} input data set.
X ≡ batch of N input data sets, i.e., input batch 309.
x′ᵢ ≡ i^{th} first training data set, i.e., i^{th} training data set in first batch of training data
  sets.
X′ ≡ batch of N first training data sets 323 − 1.
x″ᵢ ≡ i^{th} second training data set, i.e., i^{th} training data set in second batch of training
  data sets.
X″ ≡ batch of N second training data sets 323 − 2.
```

Initially, input data 301, including an input batch 309, that contains N input data sets may be received by transformer circuitry 322 and/or retrieved by training management circuitry 340 and provided to transformer circuitry 322.

The input batch 309 may be transformed into a plurality of training batches 323-1, 323-2, by transformer circuitry 322. Transformations may include, but are not limited to, random cropping, horizontal flip, color jittering, grayscale, Gaussian blur, solarization, etc. Each training batch may contain N training, e.g., transformed, data sets. For example, a first training batch 323-1 may include N first training data sets,

$${x}_{i}^{′} ,$$

and a second training batch 323-2 may include N second training data sets,

$${x}_{i}^{″} .$$

For each training batch 323-1, 323-2, the following operations may be performed:

Each training data set may be encoded F(·;θ_{F}) by a respective encoder circuitry 324-1, 324-2, into a respective representation feature 325-1, 325-2, where the symbol · ≡ training data set. Each representation feature F(·;θ_{F}) may be mapped P(·;θ_{P}) by a respective projector circuitry 326-1, 326-2 into an embedding space as a respective embedding feature (zᵢ)

$${z}_{i}^{′} 327 - 1 , {z}_{i}^{″} 327 - 2 ,$$

where the symbol · ≡ representation feature F(·;θ_{F}).

Each embedding feature,

$${z}_{i}^{′} 327 - 1 , {z}_{i}^{″} 327 - 2 ,$$

may then be partitioned, as described herein, by a respective partitioning circuitry 328-1, 328-2 into a number, S, segments, each segment, s, having a dimension D_{S}. zᵢ(s, d), s=1, . . . , S, d=1, . . . , D_{S}, and D=D_{S}×S=dimension of embedding space. For example, a respective partitioned embedding feature 329-1, 329-2 may be output from a respective partitioning circuitry 328-1, 328-2, after partitioning the embedding feature vector into a plurality of segments, zᵢ(s,d), s=1, . . . , S, d=1, . . . , D_{S}. Each segment corresponds to a respective attribute type (“general attribute”). Each segment is configured to contain at least one instantiated attribute corresponding to the associated attribute type for the segment, as described herein. Each segment has an associated probability, p(s, d)≡ probability that an image (i.e., input data set) belongs to the d^{th} instantiated attribute of the s^{th} segment, as described herein. S=number of segments (i.e., number of attribute types, number of general attributes). D_{S}=number of instantiated attributes within segment.

Each segment may then be normalized by a respective normalizing circuitry 330-1, 330-2 to a respective probability distribution pᵢ(s, d) over D_{S} instantiated attributes 331-1, 331-2 using a soft max function (Eq. (1)).

An empirical joint probability distribution p(s′, s″, d′, d″) 333 may be determined between the embedding features of the training data sets over the batches of training data sets (Eq. (2)) by the joint probability circuitry 332 based, at least in part, on the respective normalized probability distributions 331-1, 331-2.

A pure entropy loss Lₑₙₜ may be determined using the pure entropy loss function 342-1 by the training management circuitry 340 based, at least in part, on the empirical joint probability distribution (Eq. (3)). It may be appreciated that the entropy loss includes entropy over diagonal elements and entropy over elements of off diagonal blocks of the block structure illustrated in FIG. 2. Minimizing the pure entropy loss function is configured to maximize the joint entropy over selected elements.

An enhanced loss, L, may be determined (Eq. (4)) using the enhanced entropy loss function 342-2 by the training management circuitry 340 based, at least in part, on the pure entropy loss, Lₑₙₜ, and based, at least in part, on and inner product term and a balancing factor, λ. The enhanced loss is configured to enhance a transformation invariance of the features.

Respective encoder network parameters, θ_{F}, and respective projector network parameters, θ_{P}, may be adjusted by training management circuitry 340 based, at least in part, on at least one of the pure entropy loss, Lₑₙₜ, and/or the enhanced loss, L, to optimize entropy.

The trained SSRL framework/system/circuitry 302 may then be applied to a selected downstream task.

Thus, an SSRL system with MUlti-Segmental Informational Coding (“MUSIC”), according to the present disclosure, may be configured to divide, i.e., partition, an embedding feature vector corresponding to a batch of input data sets into a plurality of segments, with each segment corresponding to a respective attribute type (i.e., general attribute). Each segment is configured to contain at least one instantiated attribute that corresponds to the associated attribute type for the segment. The apparatus, system, and/or method are configured to utilize information theory, e.g., entropy, and an entropy-based cost function, to help avoid trivial solutions.

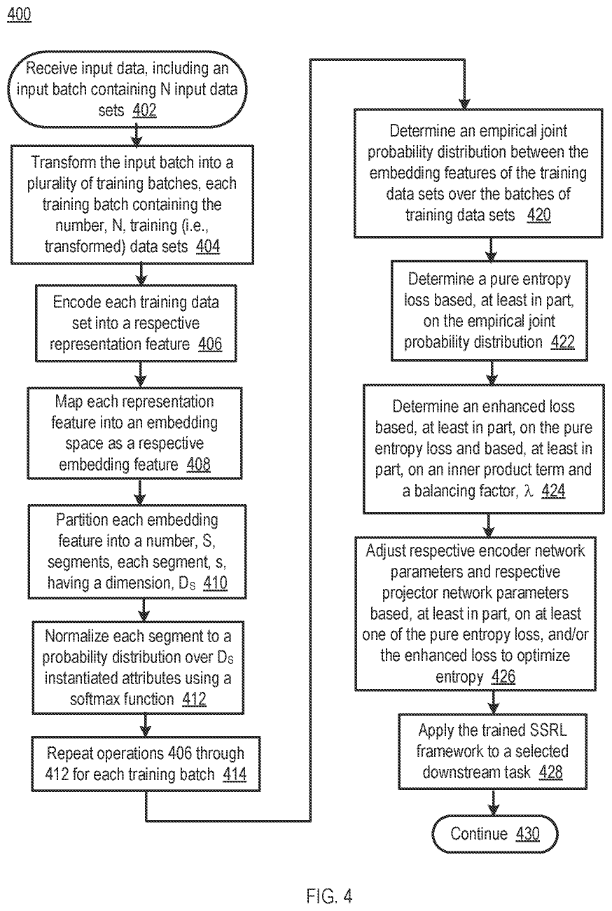

FIG. 4 is a flowchart 400 of operations for self-supervised representation learning, according to various embodiments of the present disclosure. In particular, the flowchart 400 illustrates training an SSRL circuitry. The operations may be performed, for example, by the SSRL system 300 (e.g., SSRL circuitry 302, and/or training circuitry 308) of FIG. 3.

Operations of this embodiment may begin with receiving input data at operation 402. The input data may include an input batch containing a number, N, input data sets. Operation 404 includes transforming the input batch into a plurality of training batches, each training batch containing the number, N, training (i.e., transformed) data sets. Operation 406 includes encoding each training data set into a respective representation feature. Operation 408 includes mapping each representation feature into an embedding space as a respective embedding feature. Operation 410 includes partitioning each embedding feature into a number, S, segments, each segment, s, having a dimension, D_{S}. Operation 412 includes normalizing each segment to a probability distribution over D_{S} instantiated attributes using a softmax function. Operation 414 includes repeating operations 406 through 412 for each training batch. In other words, operations 406 through 412 may be performed for each training batch.

Operation 420 includes determining an empirical joint probability distribution between the embedding features of the training data sets over the batches of training data sets. Operation 422 includes determining a pure entropy loss based, at least in part, on the empirical joint probability distribution. Operation 424 includes determining an enhanced loss based, at least in part, on the pure entropy loss and based, at least in part, on an inner product term and a balancing factor, 2. Operation 426 includes adjusting respective encoder network parameters and respective projector network parameters based, at least in part, on at least one of the pure entropy loss, and/or the enhanced loss to optimize entropy. Operation 428 includes applying the trained SSRL framework to a selected downstream task. Program flow may then continue at operation 430.

Thus, a SSRL circuitry and SSRL system may be trained based, at least in part, on a segmented embedded feature vector, and utilizing entropy loss functions.

### Experimental Data

In an experiment, a standard ResNet-50 backbone was used as the encoder that outputs a representation vector of 2,048 units. Training settings including the data augmentation (random cropping, horizontal flip, color jittering, grayscale, Gaussian blur, solarization), corresponded to training settings of an optimizer of LARS with a weight decay of 10⁻⁶ and the learning rate of Ir=batch_size/256×base_Ir, and the cosine decay schedule from 0 with 10 warm-up epochs towards the final value of 0.002. The base learning rate base_Ir was set to 0.6. A two-layer MLP (multi-layer perceptron) was used for the projector (8,192−8,160), the number of segments S=102, the segment dimension D_{S}=80, and D=D_{S}×S=8,160. The results were respectively analyzed for different feature dimensions, depths of projectors, batch size, segment dimension D_{S}, and training epochs. MUSIC introduces a single extra hyperparameter D_{S}, its effects on the performance were evaluated. All experiments were conducted on the 1,000-classes ImageNet dataset, where labels were not used for self-supervised representation learning.

Generally, this disclosure relates to a multi-segment informational coding (MUSIC) optimized with an entropy-based loss function for self-supervised representation learning. Experimental results indicate that MUSIC achieves equivalent or better representation learning results compared with existing methods in terms of linear classification. The SSRL framework, according to the present disclosure, is configured to ensure that MUSIC can avoid trivial solutions and learn discriminative and diverse features. Experimental data suggest that MUSIC may be effective using a projector with a relatively shallower MLP, and a batch size and a embedding feature dimension smaller than that used in existing methods while achieving comparable or better results.

Generally, an SSRL circuitry and SSRL system, including MUSIC support an information theory-based representation learning framework. It may be appreciated that optimized MUSIC embedding features are transform-invariant, discriminative, diverse, and non-trivial. It may be appreciated that the MUSIC technique, according to the present disclosure, does not require an asymmetric network architecture with an extra predictor module, a large batch size of contrastive samples, a memory bank, gradient stopping, or momentum updating. Empirical results suggest that MUSIC does not depend on a relatively high dimension of embedding features or a relatively deep projection head, thus, efficiently reducing a memory and computation cost.

As used in any embodiment herein, “network”, “model”, “ANN”, and “neural network” (NN) may be used interchangeably, and all refer to an artificial neural network that has an appropriate network architecture. Network architectures may include one or more layers that may be sparse, dense, linear, convolutional, and/or fully connected. It may be appreciated that deep learning includes training an ANN. Each ANN may include, but is not limited to, a deep NN (DNN), a convolutional neural network (CNN), a deep CNN (DCNN), a multilayer perceptron (MLP), etc. Training generally corresponds to “optimizing” the ANN, according to a defined metric, e.g., minimizing a cost (e.g., loss) function.

As used in any embodiment herein, the terms “logic” and/or “module” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry”, as used in any embodiment herein, may include, for example, singly or in any combination, hardwired circuitry, programmable circuitry such as computer processors comprising one or more individual instruction processing cores, state machine circuitry, and/or firmware that stores instructions executed by programmable circuitry. The logic and/or module may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc.

Memory 312 may include one or more of the following types of memory: semiconductor firmware memory, programmable memory, non-volatile memory, read only memory, electrically programmable memory, random access memory, flash memory, magnetic disk memory, and/or optical disk memory. Either additionally or alternatively system memory may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The storage device may include a machine readable storage device including any type of tangible, non-transitory storage device, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of storage devices suitable for storing electronic instructions.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1. A self-supervised representation learning (SSRL) circuitry, the SSRL circuitry comprising:
a transformer circuitry configured to receive input data, the input data comprising an input batch containing a number, N, of input data sets, the transformer circuitry configured to transform the input batch into a plurality of training batches, each training batch containing the number N training data sets;
for each training batch:
a respective encoder circuitry configured to encode each training data set into a respective representation feature,
a respective projector circuitry configured to map each representation feature into an embedding space as a respective embedding feature vector; and
a respective partitioning circuitry configured to partition each embedding feature vector into a number, S, segments, each segment having a dimension, D_{S}, each segment corresponding to a respective attribute type, and each segment containing at least one instantiated attribute corresponding to the associated attribute type for the segment.

2. The SSRL circuitry of claim 1, further comprising, for each training batch, a respective normalizing circuitry configured to normalize each segment of the corresponding partitioned embedding feature vector to a probability distribution over D_{S} instantiated attributes using a softmax function, and further comprising a joint probability circuitry configured to determine an empirical joint probability distribution between the embedding features of the training data sets over the plurality of training batches.

3. The SSRL circuitry of claim 1, wherein each encoder circuitry and each projector circuitry corresponds to a respective multilayer perceptron (MLP).

4. The SSRL circuitry of claim 1, wherein the input data is selected from the group comprising image data, text, and speech data.

5. The SSRL circuitry of claim 1, wherein a number of training batches is two.

6. A method for self-supervised representation learning (SSRL), the method comprising:
receiving, by a transformer circuitry, input data, the input data comprising an input batch containing a number, N, of input data sets;
transforming, by the transformer circuitry, the input batch into a plurality of training batches, each training batch containing the number N training data sets;
for each training batch:
encoding, by a respective encoder circuitry, each training data set into a respective representation feature,
mapping, by a respective projector circuitry, each representation feature into an embedding space as a respective embedding feature vector; and
partitioning, by a respective partitioning circuitry, each embedding feature vector into a number, S, segments, each segment having a dimension, D_{S}, each segment corresponding to a respective attribute type, and each segment containing at least one instantiated attribute corresponding to the associated attribute type for the segment.

7. The method of claim 6, further comprising, for each training batch, normalizing, by a respective normalizing circuitry, each segment of the corresponding partitioned embedding feature vector to a probability distribution over D_{S} instantiated attributes using a softmax function; and determining, by a joint probability circuitry, an empirical joint probability distribution between the embedding features of the training data sets over the plurality of training batches.

8. The method of claim 6, wherein each encoder circuitry and each projector circuitry corresponds to a respective multilayer perceptron (MLP).

9. The method of claim 6, wherein the input data is selected from the group comprising image data, text, and speech data.

10. The method of claim 6, further comprising determining, by a training circuitry, a pure entropy loss based, at least in part, on an empirical joint probability distribution, wherein minimizing the pure entropy loss during training is configured to maximize a joint entropy over a number of selected segments.

11. The method of claim 10, wherein a pure entropy loss function is:
$${L}_{ent} = \frac{1}{{S}^{2}} {\sum }_{{s}^{′} = 1}^{S} {\sum }_{{s}^{″} = 1}^{S} {\sum }_{{d}^{′} = 1}^{{D}_{S}} {\sum }_{{d}^{″} = 1}^{{D}_{S}} ( 1 - ( {s}^{′} = {s}^{″} , {d}^{′} \neq {d}^{″} ) ) p ( {s}^{′} , {s}^{″} , {d}^{′} , {d}^{″} ) log ( p ( {s}^{′} , {s}^{″} , {d}^{′} , {d}^{″} ) ) .$$

12. The method of claim 11, further comprising, determining by the training circuitry, an enhanced loss based, at least in part on the pure entropy loss, and based, at least in part on an inner product term, the enhanced loss configured to enhance a transformation invariance of a plurality of features.

13. A self-supervised representation learning (SSRL) system, the SSRL system comprising:
a computing device comprising a processor, a memory, an input/output circuitry, and a data store; and
an SSRL circuitry comprising:
a transformer circuitry configured to receive input data, the input data comprising an input batch containing a number, N, of input data sets, the transformer circuitry configured to transform the input batch into a plurality of training batches, each training batch containing the number N training data sets,
for each training batch:
a respective encoder circuitry configured to encode each training data set into a respective representation feature,
a respective projector circuitry configured to map each representation feature into an embedding space as a respective embedding feature vector, and
a respective partitioning circuitry configured to partition each embedding feature vector into a number, S, segments, each segment having a dimension, DS, each segment corresponding to a respective attribute type, and each segment containing at least one instantiated attribute corresponding to the associated attribute type for the segment.

14. The SSRL system of claim 13, wherein the SSRL circuitry further comprises, for each training batch, a respective normalizing circuitry configured to normalize each segment of the corresponding partitioned embedding feature vector to a probability distribution over D_{S} instantiated attributes using a softmax function, and the SSRL circuitry further comprises a joint probability circuitry configured to determine an empirical joint probability distribution between the embedding features of the training data sets over the plurality of training batches.

15. The SSRL system of claim 13, wherein each encoder circuitry and each projector circuitry corresponds to a respective multilayer perceptron (MLP).

16. The SSRL system of claim 13, wherein the input data is selected from the group comprising image data, text, and speech data.

17. The SSRL system of claim 13, further comprising a training circuitry configured to determine a pure entropy loss based, at least in part, on an empirical joint probability distribution, wherein minimizing the pure entropy loss during training is configured to maximize a joint entropy over a number of selected segments.

18. The SSRL system of claim 17, wherein a pure entropy loss function is:
$${L}_{ent} = \frac{1}{{S}^{2}} {\sum }_{{s}^{′} = 1}^{S} {\sum }_{{s}^{″} = 1}^{S} {\sum }_{{d}^{′} = 1}^{{D}_{S}} {\sum }_{{d}^{″} = 1}^{{D}_{S}} ( 1 - ( {s}^{′} = {s}^{″} , {d}^{′} \neq {d}^{″} ) ) p ( {s}^{′} , {s}^{″} , {d}^{′} , {d}^{″} ) log ( p ( {s}^{′} , {s}^{″} , {d}^{′} , {d}^{″} ) ) .$$

19. The SSRL system of claim 17, wherein the training circuitry is configured to determine an enhanced loss based, at least in part on the pure entropy loss, and based, at least in part on an inner product term, the enhanced loss configured to enhance a transformation invariance of a plurality of features.

20. A computer readable storage device having stored thereon instructions that when executed by one or more processors result in the following operations comprising: the method according to claim 6.
